(19) United States
(12) Patent Application Publication
(10) Pub. No.: US 2004/0167896 A1
(43) Pub. Date: Aug. 26, 2004

(54) Content management portal and method for communicating information

(76) Inventor: William Joseph Eakin, Mt. Laurel, NJ (US)

Correspondence Address: HEWLETT-PACKARD DEVELOPMENT COMPANY, Intellectual Property Administration, P.O. Box 272400, Fort Collins, CO, 80527-2400, US

(21) Appl. No.: 10/370,377

(22) Filed: Feb. 20, 2003

(51) Int. Cl. G06F 17/30; G06F 7/00

(52) U.S. Cl. 707/10

(57) ABSTRACT

A content management portal includes a user interface configured to receive information from a client via a web browser, the information associated with a human-readable digital asset, wherein the web browser presents a graphical user interface configured to render a representation of the human-readable digital asset. The content management portal further includes a management engine coupled to the user interface and configured to use a hypertext markup language tag library to communicate with a WebDAV compatible storage device.

### BACKGROUND

Databases have been a staple of business computing from the very beginning of the digital era. The relational database was first described in 1970 in a paper written by E. F. Codd, a researcher at IBM. Since then, relational databases have grown in popularity to become a standard information management tool.

Originally, databases were flat. This means that the information was stored in one long text file (e.g., a tab-delimited file). A special character, such as a vertical bar (|) separates each entry in a tab-delimited file. Each entry may contain multiple pieces of information in fields grouped together as a record. The use of a text file necessitates a sequential search of the file for specific information or to create reports that include only select fields from each record. Table I includes an example of a delimited file created by a flat database program.

TABLE I

Lname, FName, Age, Salary|Smith, John, 35, $28000|Doe, Jane,
28, $32500|Brown, Scott, 41, $26500|Howard, Shemp, 48,
$35900|Taylor, Tom, 22, $25000

In contrast, a relational database enables efficient storing, searching, retrieving, and reporting of stored information. A user of a relational database can sort information based on any field and generate reports that contain only select fields from each record. Unlike delimited files, relational databases use tables to store information. The standard fields and records are represented as columns (fields) and rows (records) in a table. Table II includes an example of a table from a relational database.

TABLE II

| Lname | FName | City | Age | Salary |
|---|---|---|---|---|
| Smith | John | 3 | 35 | $28000 |
| Doe | Jane | 1 | 28 | $32500 |
| Brown | Scott | 3 | 41 | $26500 |
| Howard | Shemp | 4 | 48 | $35900 |
| Taylor | Tom | 2 | 22 | $25000 |

In the relational database example, field comparisons, such as a comparison of salaries and ages, are more easily performed because the information is arranged in columns. The relational database model takes advantage of this uniformity to build completely new tables using required information from existing tables. In other words, relational database model uses a relationship of similar information fields to increase the speed and versatility of the database.

Each table contains a column or columns that the model can search to gather information from that table. For example, Table III below matches the number in the “City” column of Table II with the name of a city.

TABLE III

| City # | City Name |
|---|---|
| 1 | Boston |
| 2 | London |
| 3 | New York |
| 4 | Los Angeles |

By storing this information in another table, the relational database model can create a single small table with the locations that can then be used for a variety of purposes by other tables in the database. A relational database may contain hundreds or even thousands of tables to use to quickly find select information stored in other database tables at any given time.

Relational databases are typically created by operators using a special programming language, known as structured query language (SQL). SQL is a standard for database interoperability. SQL is the foundation for many popular database applications available today, including Microsoft Access® and Oracle®. Microsoft Access® and Oracle® are registered trademarks of the Microsoft Corporation of Redmond, Wash., U.S.A. and the Oracle Corporation of Redwood City, Calif., U.S.A., respectively.

The ubiquitous nature of computing devices and networks has led to the proliferation of digital assets on computers and within storage devices. These digital assets include multiple data types associated with multiple product types, such as video, audio, dynamic documents, and slide presentations, among others. Many of these digital assets are difficult to characterize using the paradigm of the relational database. A significant factor that leads to the difficulty in quantifying these content-rich media assets is that the items are generally human readable rather than machine readable as they often contain little or no data that can be consistently indexed and searched.

Current processes for addressing content-rich digital assets are often decentralized, with various groups or individuals creating and storing assets using individualized methods. This approach to generating and managing content-rich digital assets makes it difficult for others to locate, identify, reuse, and otherwise exploit these assets. In a business enterprise, this decentralized and often random approach can contribute to duplicative efforts and inconsistencies in quantifying assets.

Furthermore, present mechanisms for storing digital assets and metadata can be difficult for novice users. For example, Web-based Distributed Authoring and Versioning (WebDAV) is a set of extensions to the hypertext transfer protocol (HTTP) that enables users to collaboratively edit and manage files on web servers. In addition to enabling users to share folders and files, WebDAV has the ability to retrieve and set preferred operatorational parameters associated with an application. However, copying files and folders to WebDAV compliant storage facilities can be confusing because the operator must follow a multiple step procedure to prepare the source and destination to complete a data copy task. Accordingly, improved ways are needed to gather, store, manage, and use content-rich digital assets.

### SUMMARY

In accordance with an embodiment of a content management system, a content portal is disclosed. The content portal includes a user interface configured to receive information from a client via a web browser, the information associated with a human-readable digital asset. The web browser presents a graphical user interface that directs the content portal to integrate human-readable digital assets in the content management system. The management engine, in accordance with the direction of the graphical user interface, is configured to use a hypertext markup-language tag library to communicate with a WebDAV compatible storage device.

### BRIEF DESCRIPTION OF THE DRAWINGS

The content portal and method for communicating information are illustrated by way of example and not limited by the implementations depicted in the following drawings. The components in the drawings are not necessarily to scale relative to each other; emphasis instead is placed upon clearly illustrating the principles of the content portal and method for communicating information. Moreover, in the drawings, like reference numerals designate corresponding parts throughout the several views.

FIG. 1 is a schematic diagram illustrating an embodiment of a content management system in which a content portal resides.

FIG. 2 is a functional block diagram of an embodiment of a repository layer as shown in FIG. 1.

FIG. 3 is a schematic diagram of an embodiment of a metadata store as shown in FIG. 1.

FIG. 4 is a functional block diagram of an embodiment of a content portal as shown in FIG. 1.

FIG. 5 is a flow diagram illustrating an embodiment of a method for managing digital assets that can be implemented using a content portal as shown in FIG. 4.

FIG. 6 is a schematic diagram of an embodiment of a content portal login interface that can be implemented by a content portal as shown in FIG. 4.

FIG. 7 is a schematic diagram of an embodiment of a content provider interface that can be implemented by a content portal as shown in FIG. 4.

FIG. 8 is a schematic diagram of an embodiment of a content-reviewer interface that can be implemented by a content portal as shown in FIG. 4.

FIG. 9 is a schematic diagram of an embodiment of a content publisher interface that can be implemented by a content portal as shown in FIG. 4.

FIG. 10 is a schematic diagram of an embodiment of a content consumer interface that can be implemented by a content portal as shown in FIG. 4.

FIG. 11 is a functional block diagram illustrating how a tag library can be used to communicate with a WebDAV storage device.

FIG. 12 is a flow diagram illustrating an embodiment of a method for communicating using a tag library as shown in FIG. 11.

FIG. 13 is a flow diagram illustrating an alternative embodiment of a method for communicating using a tag library as shown in FIG. 11.

FIG. 14 is a schematic diagram of an embodiment of an interface that directs the integration of media content and metadata in a WebDAV data store using a content portal as shown in FIG. 4.

### DETAILED DESCRIPTION

An embodiment of an improved content management system is directed to a content portal tool that automates the capture of human-readable digital assets and provides for their management, modification, and delivery via HTTP. Human-readable “digital assets” include a variety of data content-rich materials such as, but not limited to, video, audio, and audio-visual files, dynamic documents, slide presentations, among others. These data content-rich materials include information that is not readily extractable by machines.

In one embodiment, the content portal tool is used to manage presentations produced across a distributed network infrastructure within a business enterprise. The content portal tool provides for a plurality of users each having different roles in the life cycle of the digital asset. The content portal tool provides an adaptable interface suited for digital asset providers, reviewers, publishers, and consumers.

In alternative embodiments, an individual can use the content portal tool to store and manage human-readable digital assets of their own without using a database product. Individually owned human-readable digital assets can include digital video, audio, photographs, etc.

In one embodiment, the content portal tool further includes a management engine that leverages the Web Distributed Authoring and Versioning (WebDAV) protocol, an extension to the hypertext transfer protocol (HTTP), to store digital assets, receive, and structure data describing the assets, and in some cases, edit both types of information on network-coupled web servers. WebDAV is a specification that addresses the storage of all three object types (i.e., digital assets, metadata about the assets, and a data structure for their storage) and is currently in use in network storage solutions and web servers. In addition, WebDAV is supported in many authoring tools. WebDAV is divided into three separate specifications, each of which address particular storage operations: WebDAV, DASL (Distributed Authoring and Versioning Searching and Locating), and Delta-V (Versioning).

The management engine uses information entered by the digital asset provider via the provider interface to generate a metadata index that is associated with the digital asset on the web server. Various other operators serving in one of the operator roles of digital asset reviewer, publisher, and consumer, manipulate and/or use the metadata index to approve or disapprove, publish or hold, locate and view, a select digital asset.

One embodiment of the content portal tool communicates with a WebDAV compatible data storage device using hypertext markup language encoded commands and a tag library. The tag library includes commands configured to put, search, and retrieve information from the WebDAV compatible data storage device.

A web browser interface is configured to simplify the integration of human-readable digital assets in a WebDAV data store from the perspective of a provider of the digital asset.

Content Management System

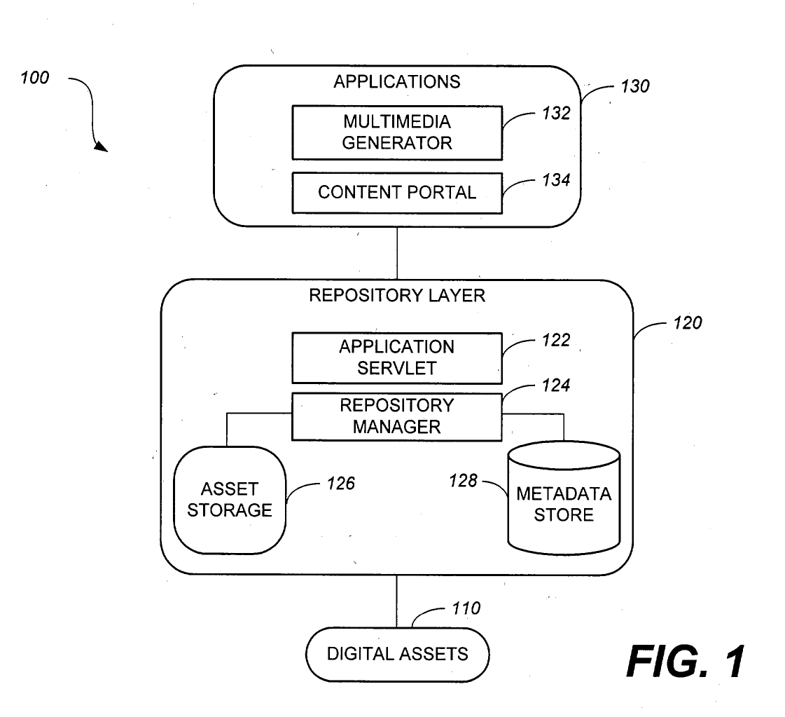

The digital asset, and the constructs for its storage and access are important aspects of a content management system. The content management system illustrated in FIG. 1 is an exemplary embodiment of a system that includes client applications that provide, store, manipulate, and access digital assets. In this regard, content management system 100 comprises a repository layer 120 that exposes digital assets 110 to client applications 130. In the illustrated example, client applications include multimedia generator 132 and content portal 134. However, content management system 100 can include any arrangement of additional client applications (not shown for simplicity of illustration and description).

The repository layer 120 includes an application servlet 122 and a repository manager 124 that integrates digital assets 110 via asset storage 126 and metadata store 128. Servlets are a popular component used in building web applications. Servlet technology provides web service developers with a simple consistent mechanism for extending the functionality of existing business systems accessible to end users via a web server. Servlets provide a component-based platform independent method for building web applications without the performance limitations inherent in the common gateway interface (CGI—a web scripting facility).

Providing an abstraction to the digital assets 100 is an important function in the development of rich media-based applications and services. Defining the repository layer 120 has the same importance as defining a common language and application programming interface (API) for accessing traditional relational database systems. The repository layer 120 is comprised of asset storage 126, metadata about the asset in medadata store 128, and the structure to store this information as provided by repository manager 124. The repository layer 120 provides features such as insert, update, delete and query.

Where and how to store human-readable digital assets, metadata, and the associations between them, is a complex problem. Different client applications 130 can have vastly different requirements for asset storage 126. The content management system 100 provides an abstract storage mechanism that supports heterogeneous storage for digital assets 110, related metadata, and data structures.

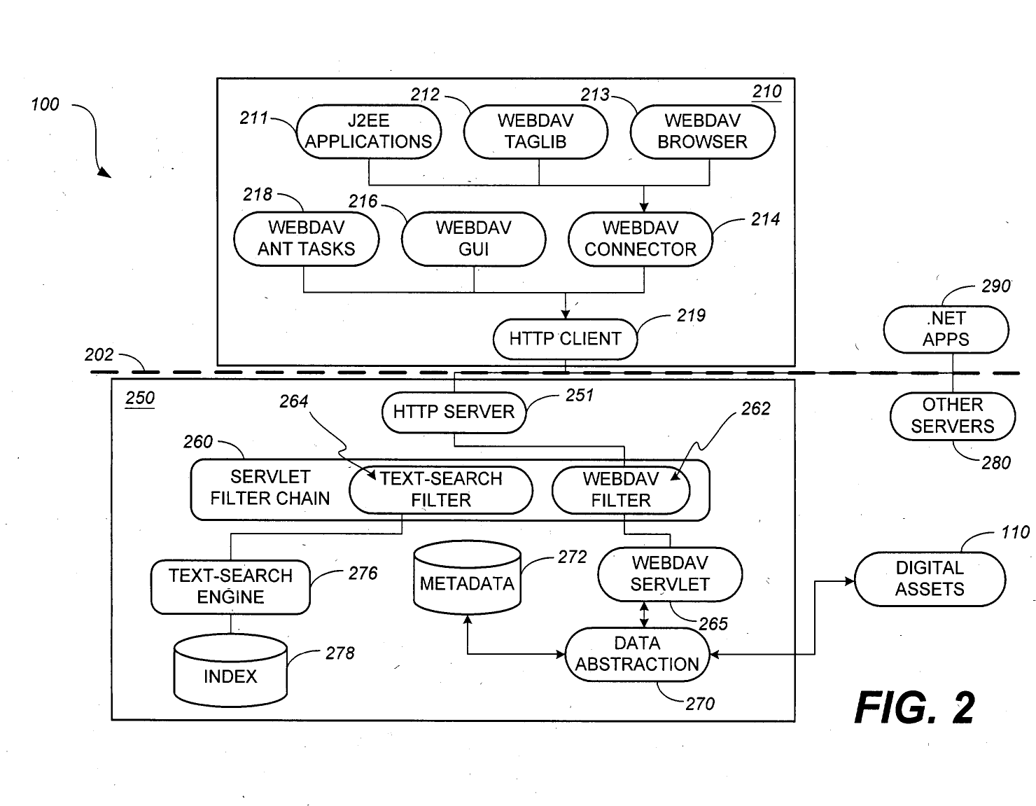

The storage abstraction architecture uses many components which create both the abstraction for the storage system as well as a usable storage infrastructure upon which systems are created. While much of the storage abstraction is viewed as a server side layer, there are many layers of connectivity in the repository layer 120. The functional block diagram of FIG. 2 further illustrates the various components in an embodiment of the repository layer 120.

FIG. 2 is a functional block diagram of an embodiment of a repository layer as shown in FIG. 1. In the embodiment illustrated in FIG. 2, content management system 100 includes client-side components 210 and server-side components 250, other servers 280, and .net applications 290 coupled via network infrastructure 202. Client-side components 210 are operable on workstations, laptop computers, and a host of other computing devices. Client-side components 210 include a HTTP client interface 219 for establishing a network communication session via the network infrastructure 202, as well as a host of content management system (CMS) interface modules. As illustrated in FIG. 2, the CMS interface modules comprise a WebDAV connector 214, a WebDAV graphical-user interface (GUI) 216, and a WebDAV access network transport (ANT) tasks module 218 coupled to the HTTP client interface 219.

WebDAV connector 214 interfaces Java™ 2 Enterprise Edition (J2EE) applications 211, WebDAV library applications 212, and/or WebDAV browser 213. WebDAV connector 214 provides a standard client API for connecting into a WebDAV server. J2EE applications 211 and WebDAV library applications 212 work together with the WebDAV browser 213 to expose the functionality available in WebDAV servlet 265 and the text-search engine 276 to a web client coupled via the network infrastructure 202. WebDAV browser 213 is a simple web interface that currently allows browsing of any WebDAV server. Content portal 134 (FIG. 1) can be implemented as a WebDAV browser 213. Alternative embodiments may include other types of applications, programs, data stores, and the like that interface through the WebDAV connector 214 and/or HTTP client 219.

Server-side components 250 are operable on web servers. Server-side components 250 include a HTTP server 251, a servlet filter chain 260, a text-search engine 276, and WebDAV servlet 265. Integrating the text-search engine 276 into the architecture provides a common mechanism for creating text-based search capabilities along side any system that supports WebDAV. For example, the text-search engine 276 can be implemented using Lucene, a text-based search engine. In embodiments that use Lucene, the text-search filter 276 is a Lucene text-search filter. Alternative embodiments may include additional servlets, other search engines and data stores.

HTTP server 251 establishes a network communication session with one or more clients via network infrastructure 202. Servlet filter chain 260 receives and processes web-service requests from HTTP server 251. In this regard, processing can include parsing of HTTP packets to extract header information to determine the identity of the web-service client and identifying one or more service modules required to respond appropriately to the web-service request. Processing may further include execution management for various tasks and functions associated with text-search engine 276 and WebDAV servlet 265.

For example, when WebDAV filter 262 identifies a web-service request that needs functionality provided by the WebDAV servlet 265, the WebDAV filter 262 forwards data, commands, pointers, etc. to the WebDAV servlet 265 to complete the requested task. Upon completion, WebDAV filter 262, in accordance with the web-service request may forward the request to other filters in the servlet filter chain 260, such as text-search engine 276, or may redirect the web-service request to other servers 280 at that time as may be necessary to complete tasks identified in the request. The WebDAV filter 262 is an extension to current HTTP servlet filters allowing for extraneous processing on web service requests.

The text-search filter 264 identifies a web-service requests that need to search text. The text-search filter 264 forwards data, commands, pointers, etc. to the text-search engine 276 to complete the requested task. Upon completion, the text-search filter 264, in accordance with the web-service request may forward the results to the WebDAV servlet 265, which may be programmed to format the results before returning the results of the text search to a client component.

The WebDAV servlet 265 provides a simple interface allowing servlet developers to extend any WebDAV server, create proxies to single and/or aggregate WebDAV servers, and/or create custom decisions based on request information.

Server-side components 250 can include open source components. Various components focused on content management systems can be integrated in the functional structure illustrated in FIG. 2. These components provide an abstraction layer that allows selection of the type of mechanism to use for all of data stores including content and metadata. The abstraction layer enables in-memory stores, database stores, XML stores, among others.

As further illustrated in the embodiment of FIG. 2, WEBDAV servlet 265 is integrated with a data abstraction interface 270 that exposes a metadata index 272 and digital assets 110 to the WEBDAV servlet 265. Metadata processing is an important aspect of applications such as content portal 134 that attempt to expose human-readable digital assets 110 to clients via computing devices in a way in which the clients can meaningfully exploit the assets.

Metadata

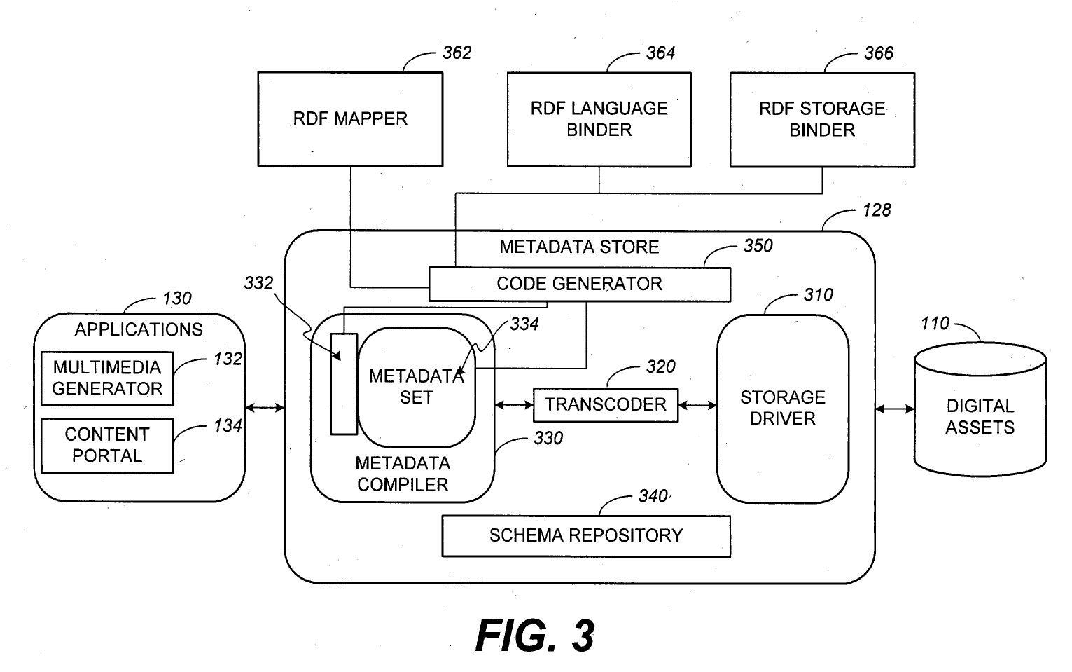

Metadata processing is an integral part of any rich media application. Typically, rich media assets do not contain data that is easily indexed, searched, or used for decision-making processes in applications. Asset metadata is similar to traditional business-processing data, but it is different in that it is primarily human-readable rather than machine-readable. The structure of data is not fixed as in business-oriented systems, and the set of data to be tracked is dynamic. The metadata storage framework illustrated in FIG. 3 provides a mechanism by which digital asset metadata can be deployed similar to application components while concurrently providing the flexibility required by rich media applications.

The metadata store 128 as illustrated in FIG. 3 is based on work in the digital library community. In one embodiment, metadata store 128 is structured under a Warwick Framework. The Warwick Framework architecture is based on a container architecture, familiar in J2EE architectures. Metadata sets 334 are deployed to this container and are made available through both common and specific APIs. Common APIs allow for dynamic discovery of metadata while the specific APIs allow applications to be written against specific metadata sets 334. FIG. 3 shows the overall architecture of the metadata store 128. A deployable component to this container is a metadata set 334.

The deployed metadata set 334 consists of a description of the relationships between the properties in the set, the native type binding of those properties, and the binding to the storage layer. The relationships between the properties in a metadata set 334 can be described in a general way so that the metadata description can be deployed to different containers that may be implemented on different data platforms. The native type binding description as defined by resource description framework (RDF) mapper 362, RDF language binder 364, and RDF storage binder 366 is specific to a programming language and is used to generate code (e.g., in code generator 350) that implements the binding. RDF storage binder 366 allows properties in multiple metadata sets to map to a single value in storage (the canonical property). Part of the storage binding defines the transcoding required in transcoder 320 to transform a property value encoded in storage driver 310 into the proper encoding for a specific metadata set 334.

A client application 130, such as content portal 134, makes calls on the metadata store 128 via metadata set interface 332 to the object that holds the values of the properties, and on any metadata sets 334 integrated in the metadata framework. A storage driver 310 manages the persistence of property values. FIG. 3 further illustrates the flow of data between the components of the metadata store 128. The storage driver 310 provides native type binding through a generic, Java database connectivity (JDBC)-like API or another suitable API. The higher-level metadata set API delivers property values not only in the proper native type but also in the proper encoding for that metadata set. An application can choose to use such an API in order to take advantage of the metadata transcoding facilities built into the metadata store 128 and to avoid having metadata mappings for each component in an application.

The metadata store 128 is discovered at runtime via the Java naming and directory interface (JNDI). The JNDI name of the metadata store 128 is of the form metadata: configurationURL. The configurationURL can be in many different forms. The most basic is an absolute file uniform resource locator (URL), such as file:/c:/hpmw/hpas/config/metadata-container.xml, which can be used to locate the metadata store 128. A relative URL, such as/metadata-container.xml, can be used when the configuration file is in a Web application (WAR) file, accessible from the document root, or when the configuration file is in the class path. The JNDI provider will return at most one copy of the metadata store 128 object, configured as specified by the configuration file.

Configuring the metadata store 128 consists of configuring the schema repository 340 (e.g., a Jena model), features of the metadata compiler 330, the storage driver 310, and the deployed metadata sets 334. The configuration starts with the XML element metadata-container. Under this element are the elements storage-driver 310, schema-repository 340, a metadata compiler 330, as well as one or more elements in the metadata-set 334. The schema-repository element 340 has a single child, class-name, that indicates a class that implements the Jena Model interface, allowing persistent or transient models to be used for the schema repository 340.

Content Portal

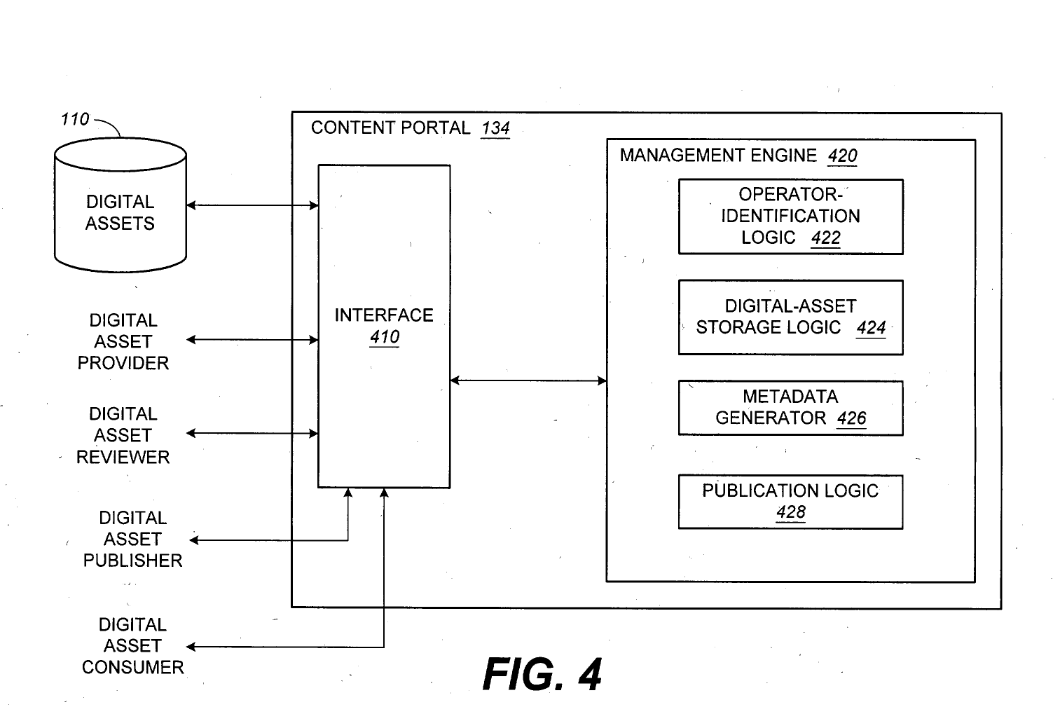

An embodiment of the content portal 134 is illustrated in the functional block diagram of FIG. 4. Content portal 134 includes an interface 410 for receiving, storing, and/or manipulating digital assets 110 and associated metadata (not shown). Interface 410 further includes logic configured to communicate with client operators serving in multiple roles or functions during the life cycle of a digital asset 110. As indicated in FIG. 4, interface 410 communicates with digital asset providers, reviewers, publishers, and/or consumers. In preferred embodiments, interface 410 provides a graphical-user interface such as those commonly provided by web browsers.

Content portal 134 further includes management engine 420. As indicated in FIG. 4, management engine 420 includes operator-identification logic 422, digital asset storage logic 424, a metadata generator 426, and publication logic 428. Operator-identification logic 422 identifies client operators of the content portal 134 and assigns a role to the client operator. In the illustrated embodiment, operator roles include provider, reviewer, publisher, and/or consumer.

An operator, acting in the role of a provider, copies and stores one or more digital assets 110 to a WebDAV folder on a WebDAV compliant web server. As part of the copy and storage process, the data provider is presented a set of prompts to enter information about the asset. Metadata generator 426 and digital asset storage logic 424 use the information to both construct the metadata, its structure, and to locate and store the digital asset 110.

An operator, acting in the role of a reviewer, uses the metadata to search, locate, and access previously provided digital assets 110 stored on a web server. The reviewer, after accessing and observing and/or listening to the underlying information within the digital asset 110, can elect to update an approval field in the metadata associated with the digital asset 110.

An operator, acting in the role of a publisher, also uses the metadata to search, locate, and access previously provided digital assets 110 stored on a web server. The publisher, after accessing and observing and/or listening to the underlying information within the digital asset 110 and perhaps verifying that a reviewer has approved of the underlying information in the digital asset, can elect to update a publish, hide, and/or announce field in the metadata associated with the digital asset 110.

Publication logic 428 retrieves the publish, hide, and/or announce fields from the metadata and further extracts any related configuration information before responding in accordance with parameters set by the publisher. Specifically, the publisher elects whether to publish or hold, hide or expose, and can affirmatively announce publication of the digital asset 110.

In an embodiment, the content portal 134 is one or more source programs, executable programs (object code), scripts, and/or other collections each comprising a set of executable instructions to be performed. It should be understood that the interface 410 and management engine 420 can be embodied in any computer-readable medium for use by or in connection with an instruction-execution system, apparatus, or device, such as a computer-based system, processor-containing system, or other system that can fetch the instructions from the instruction-execution system, apparatus, or device, and execute the instructions.

In the context of this disclosure, a “computer-readable medium” can be any means that can store, communicate, propagate, or transport a program for use by or in connection with the instruction-execution system, apparatus, or device. The computer-readable medium can be, for example but not limited to, an electronic, magnetic, optical, electromagnetic, infrared, or semiconductor system, apparatus, device, or propagation medium now known or later developed. Note that the computer-readable medium could even be paper or another suitable medium upon which the program is printed, as the program can be electronically captured, via for instance optical scanning of the paper or other medium, then compiled, interpreted or otherwise processed in a suitable manner if necessary, and then stored in a computer memory.

Those skilled in the art will understand that various portions of the interface 410 and the management engine 420 can be implemented in hardware, software, firmware, or combinations thereof. In separate embodiments, the interface 410 and the management engine 420 are implemented using a combination of hardware and software or firmware that is stored in memory and executed by a suitable instruction-execution system. If implemented solely in hardware, as in an alternative embodiments, the interface 410 and the management engine 420 can be separately implemented with any or a combination of technologies which are well-known in the art (e.g., discrete-logic circuits, application-specific integrated circuits (ASICs), programmable-gate arrays (PGAs), field-programmable gate arrays (FPGAs), etc.), and/or later developed technologies. In preferred embodiments, the functions of the interface 410 and the management engine 420 are implemented in a combination of software and data executed and stored under the control of a computing device. It should be noted, however, that neither the interface 410 nor the management engine 420 are dependent upon the nature of the underlying computing device and/or upon an operating system in order to accomplish their respective designated functions.

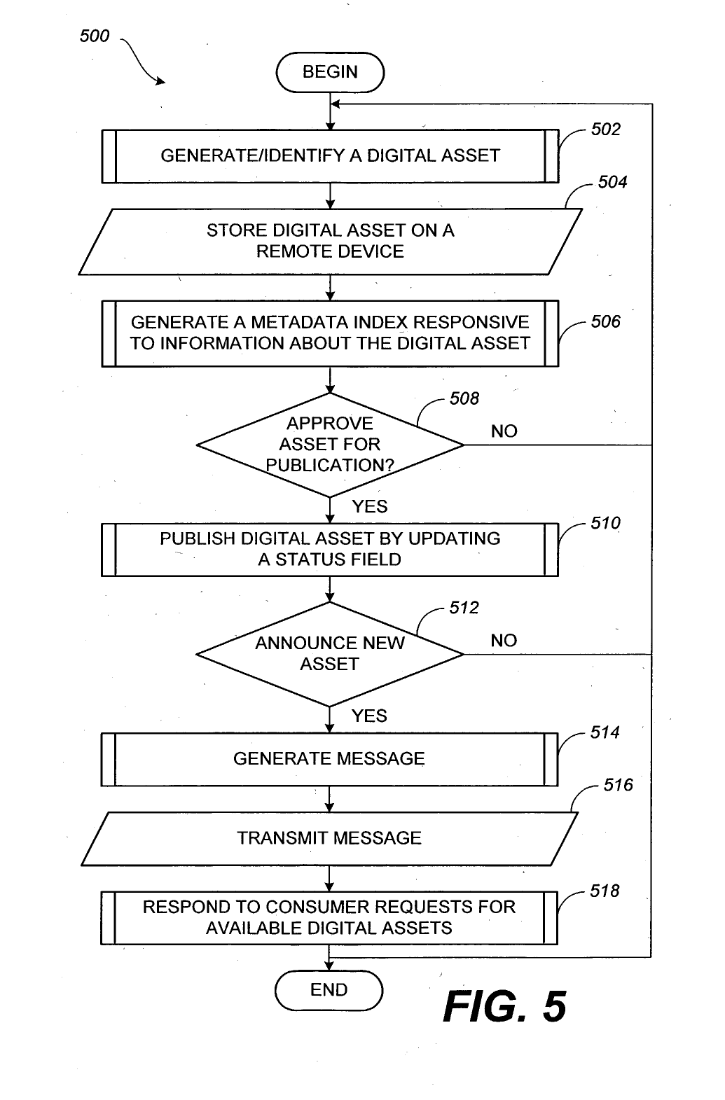

Reference is now directed to FIG. 5, which presents an embodiment of a method 500 for managing content-rich digital assets. Any process descriptions or blocks in the flow diagrams of FIGS. 5, 12, and 13 should be understood to represent modules, segments, or portions of code which include one or more executable instructions for implementing specific logical functions or steps in the respective process. Alternate implementations are included within the scope of the preferred embodiment of the present invention in which functions may be executed out of order from that shown or discussed, including substantially concurrently or in reverse order, depending on the functionality involved, as would be understood by those reasonably skilled in the art of the present invention.

In this regard, method 500 begins with block 502 where a provider of a digital asset 110 or other operator generates and/or identifies a digital asset 110 desired to be added to a data store managed by the content portal 134. Thereafter, as indicated in input output processing block 504, the content portal 134 stores the digital asset 110 on a remote web server or storage device coupled to a web server. Next, as indicated in block 506, the content portal 134 generates a metadata index responsive to information entered by the provider or some other operator of the content portal 134 that characterizes the asset.

In some embodiments, the content portal 134 is configured to support an operator role of a digital asset reviewer. In these embodiments (not depicted in the flow diagram of FIG. 5), a digital asset reviewer accesses the metadata associated with a digital asset 110 of interest. The reviewer, after accessing and observing or otherwise verifying the quality or accuracy of the human-readable information therein is given the opportunity to modify a metadata parameter to indicate approval or disapproval of the present state of the digital asset 110. In either case, the digital asset reviewer entered metadata parameter is further associated with the digital asset 110 and an indication thereof can be observed by operators serving other roles.

In the embodiment illustrated in FIG. 5, an operator in the role of a publisher approves or disapproves the digital asset for publication as indicated in decision block 508. When the publisher disapproves, as indicated by the flow-control arrow labeled, “NO” exiting decision block 508, the content portal 134 stores the result in the metadata associated with the digital asset for observation by other operators and returns to repeat the functions illustrated in blocks 502 through 506 as described above.

Otherwise, when the publisher approves the digital asset for publication as indicated by the flow-control arrow labeled, “YES” exiting decision block 508, the content portal 134 publishes the digital asset by updating a status field in the metadata associated with the digital asset as indicated in step 510. The content portal 134 then prompts the publisher if it is desired to announce the arrival of the new asset in the content management system. When the publisher does not wish to affirmatively announce the arrival of the digital asset, as indicated by the flow-control arrow labeled, “NO” exiting decision block 512, the content portal 134 stores the result in the metadata associated with the digital asset for observation by other operators and returns to repeat the functions illustrated in blocks 502 through 510 as described above.

Otherwise, when the publisher desires to affirmatively announce the arrival of the digital asset as indicated by the flow-control arrow labeled, “YES” exiting decision block 512, the content portal 134 announces the arrival of the digital asset by generating a message as indicated in block 514 and transmits the messages as indicated in input/output block 516. Note that the message can be an email message delivered in accordance with an address book stored in the metadata associated with the digital asset. Alternatively, messages, including video and audio presentations can be transmitted in accordance with other criteria as may be desired. Thereafter, as indicated in block 518, the content portal 134 responds to consumer requests and perhaps other requests from operators with roles other than consumer. The method 500 then repeats the various functions associated with the illustrated blocks as desired.

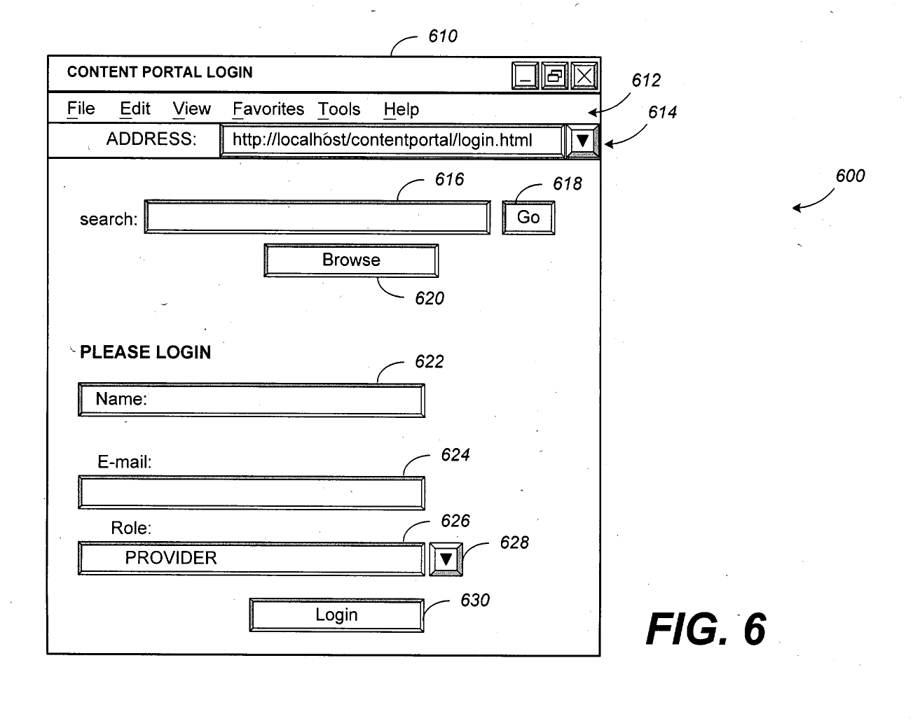

FIG. 6 illustrates an embodiment of an operator login interface 600 that can be generated and used by interface 410 of the content portal 134 to identify various operators and their associated roles. In this regard, content portal login 610 includes a drop-down menu 612, along with an address-entry field 614. The address-entry field 614 is a feature commonly provided by web browsers. As illustrated, the address-entry field 614 may be associated with an arrow pushbutton to enable an operator of the interface 600 to scroll through a list of available HTML files associated with content portal 134.

As further illustrated in FIG. 6, content portal login 610 further includes a text search entry field 616, a text search activation pushbutton 618, and a browse pushbutton 620. Text search entry field 616 and text search activation pushbutton 618 are programmed to respond in accordance with conventional text search interfaces. Browse pushbutton 620 is configured to activate a configurable index of search terms commonly used in a present application of the content portal 134.

Content portal login 610 also includes a name entry field 622, an email address entry field 624, an operator role input field 626 along with an associated scroll button 628 that displays a menu of the supported operator roles, and a login pushbutton 630 that enters the strings and selected role label as entered by an operator of the interface 410.

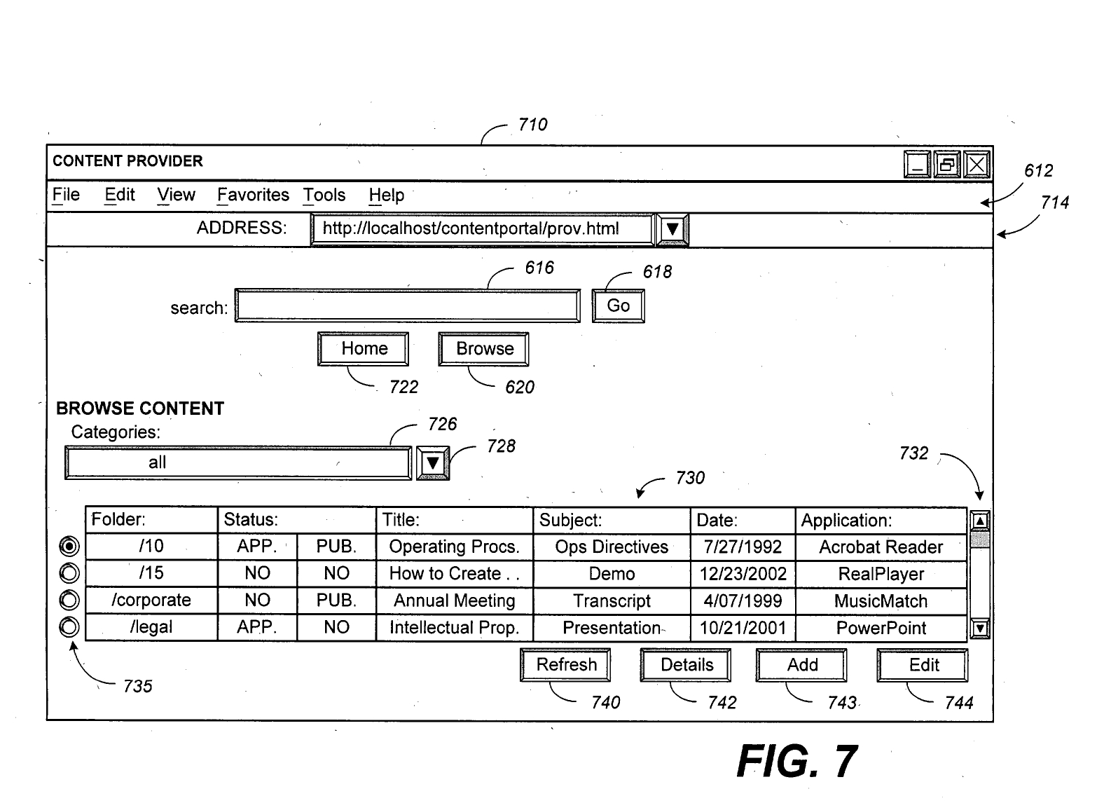

FIG. 7 illustrates an embodiment of a content provider interface 710 that can be generated and used by interface 410 of the content portal 134 to communicate with a provider of digital assets. In this regard, content provider interface 710 includes a drop-down menu 612, along with an address-entry field 714. The address-entry field 714 is a feature commonly provided by web browsers. As illustrated, the address-entry field 714 may be associated with an arrow pushbutton to enable an operator of the interface 710 to scroll through a list of available HTML files associated with content portal 134.

As further illustrated in FIG. 7, content-provider interface 710 further includes a text-search entry field 616, a text-search activation pushbutton 618, and a browse pushbutton 620. Text-search entry field 616 and text-search activation pushbutton 618 are programmed to respond in accordance with conventional text-search interfaces. Browse pushbutton 620 is configured to activate a configurable index of search terms commonly used in a present application of the content portal 134. Home pushbutton 722 is configured to link the operator to a web page that describes “provider” operation of the content portal 134.

Content-provider interface 710 also includes a category-entry field 726 and an associated scroll button for enabling a menu of the metadata fields desired in report field 730. In the embodiment illustrated in FIG. 7, a provider has requested that “all” metadata fields are included in report field 730. Report field 730 is associated with a scroll interface 732 that enables an operator to scroll through many more digital assets than can be presented within the space provided by report field 730. In the example, the report field 730 includes the WebDAV folder location, reviewer, and publisher status, title, subject, data, and the software application that can be used to access and/or observe the underlying digital asset. Other embodiments may include more or less metadata fields, such as an entry for a provider, creation date, last update date, a reviewer, publication dates, etc. as desired.

In preferred embodiments, the folder, title, and application fields are configured as links to either provide a separate interface that includes a presentation of the data-storage folder, presents the digital asset 110 using the associated application, and/or opens the associated application.

Each digital asset is provided a selection button 735. In the illustrated embodiment, the digital asset selection button 735 is provided in the left margin of the content provider interface 710. When the digital asset selection button 735 is enabled, the edit pushbutton 744 will take the provider to a digital asset metadata entry interface to revise the metadata associated with the respective digital asset as may be desired. Furthermore, when the digital asset selection button 735 is enabled, the details pushbutton 742 will take the provider to a digital asset metadata review interface to observe the metadata associated with the respective digital asset 110. Add pushbutton 743 activates a digital asset entry interface that prompts the provider to enter information required to add new content and populate the metadata index. The digital asset interface is configured to adapt based on the subject matter and storage type of the underlying digital asset 110. When the refresh pushbutton 740 is enabled, information in the report field 730 is updated in accordance with the present status of the metadata index.

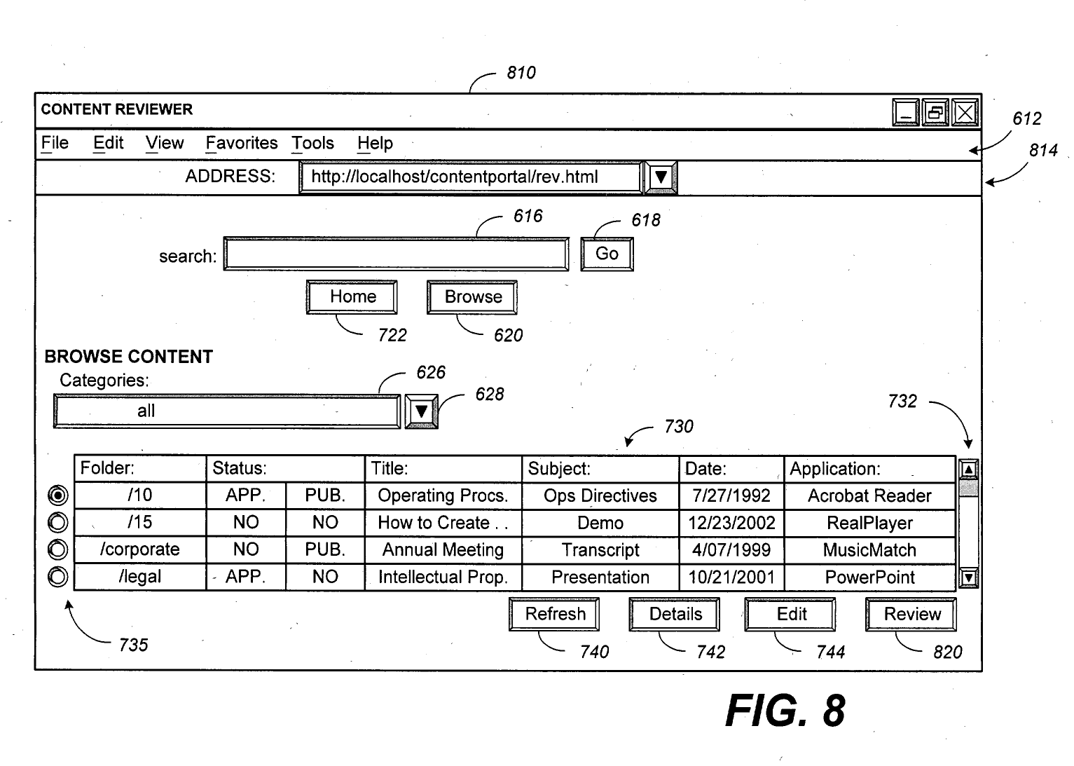

FIG. 8 illustrates an embodiment of a content-reviewer interface 810 that can be generated and used by interface 410 of the content portal 134 to communicate with a reviewer of digital assets. In this regard, content-reviewer interface 810 includes a drop-down menu 612, along with an address-entry field 814. As noted above, the address-entry, field 814 is a feature commonly provided by web browsers. As illustrated, the address-entry field 814 may be associated with an arrow pushbutton to enable an operator of the interface 810 to scroll through a list of available HTML files associated with content portal 134.

As further illustrated in FIG. 8, content-reviewer interface 810 shares many of the above-described features of the provider interface 710 illustrated in FIG. 7. The content-reviewer interface 810, however, replaces the add pushbutton 743 with a review pushbutton 820. Operator selection of the review pushbutton 820 opens the selected digital asset as indicated by the selection button in the left margin using the associated application as indicated in the metadata for the digital asset. Once the reviewer has made a determination as to whether the digital asset should be approved, the content portal 134 presents an approval entry interface to receive the reviewer's input. Once entered by the reviewer, the content portal 134 updates the metadata in accordance with the reviewer's entry. Thereafter, the revised metadata is available and presented to other operators of the content portal 134 in the status field of the report field 730.

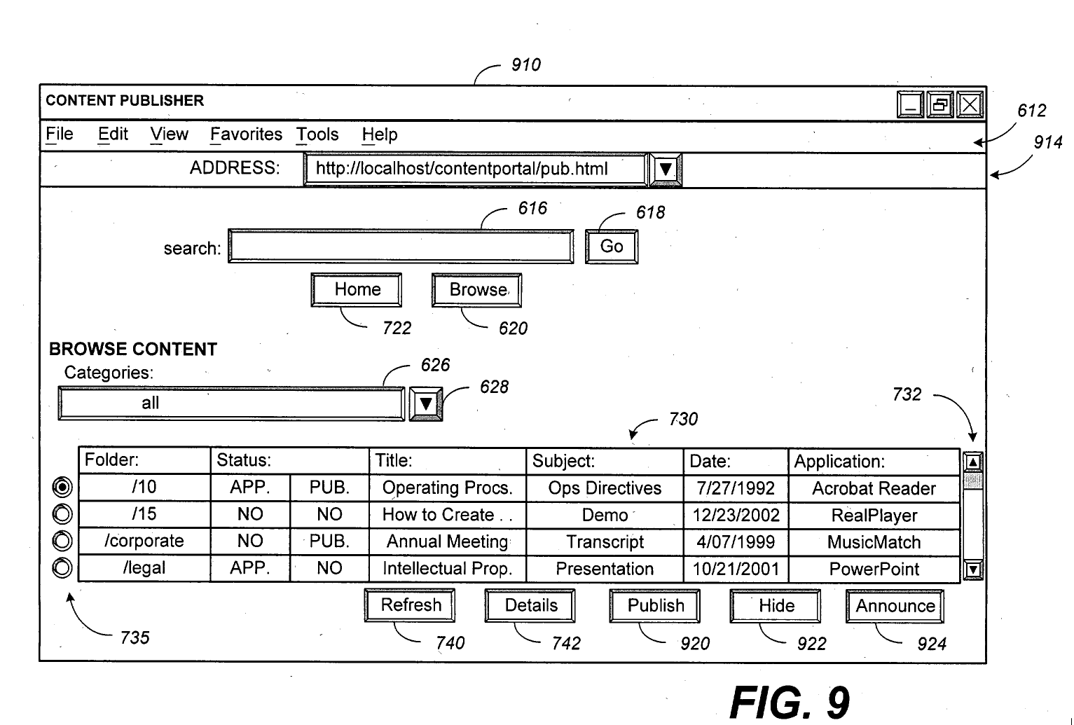

FIG. 9 illustrates an embodiment of a content-publisher interface 910 that can be generated and used by interface 410 of the content portal 134 to communicate with a publisher of digital assets. In this regard, content-publisher interface 910 includes a drop-down menu 612, along with an address-entry field 914. The address-entry field 914 is a feature commonly provided by web browsers. As illustrated, the address-entry field 914 may be associated with an arrow pushbutton to enable an operator of the interface 910 to scroll through a list of available HTML files associated with content portal 134.

As further illustrated in FIG. 9, content-publisher interface 910 shares many of the above-described features of the provider interface 710 illustrated in FIG. 7 and the reviewer interface 810 illustrated in FIG. 8. The content-publisher interface 910, however, replaces the edit pushbutton 744 and the add pushbutton 743 with publish 920, hide 922, and announce 924 pushbuttons. Operator selection of the publish pushbutton 920 updates the metadata associated with the selected digital asset. Thereafter, the revised metadata is available and presented to other operators of the content portal 134 in the status field of the report field 730.

Operator selection of the hide pushbutton 922 updates the metadata associated with the selected digital asset 110 such that subsequent consumers using the content portal 134 will not be presented with a representation containing links to open or otherwise review the associated digital asset 110. Operator selection of the announce pushbutton 924 triggers the content portal 134 to generate a message in accordance with information stored in a configuration file. The message is distributed to interested operators based on any number of addressee selection criteria.

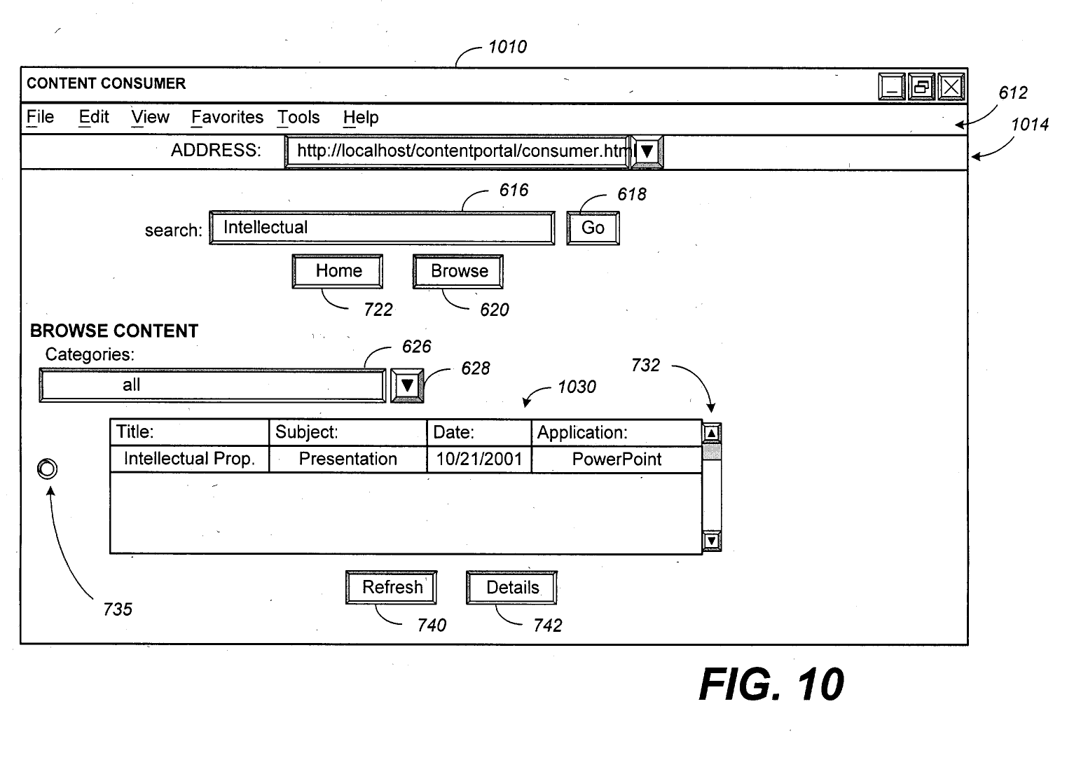

FIG. 10 illustrates an embodiment of a content-consumer interface 1010 that can be generated and used by interface 410 of the content portal 134 to communicate with a consumer of digital assets. In this regard, content-consumer interface 1010 includes a drop-down menu 612, along with an address-entry field 1014. As described above, the address-entry field 1014 is a feature commonly provided by web browsers. As illustrated, the address-entry field 1014 may be associated with an arrow pushbutton to enable an operator of the interface to scroll through a list of available HTML files associated with content portal 134.

As further illustrated in FIG. 10, content-consumer interface 1010 shares many of the above-described features of the provider, reviewer, and publisher interfaces (710, 810, and 910) illustrated in FIGS. 7-9, respectively. In the embodiment illustrated in FIG. 10, an operator of the interface 1010 has used the search entry field 616 to search the metadata for “Intellectual.” Search results field 1030 indicates one digital asset contains metadata with the word “Intellectual” in the metadata and presents the associated information as directed by category entry field 626. As in the other operator interfaces, the information provided in search results field 1030 is linked to enable an operator (i.e., a consumer or other user) of the digital asset 110 to observe the digital asset 110 using the associated application used to generate and store the digital asset 110. Preferred embodiments of the content-consumer interface 1010 include a search results field 1030 that differs from the search results field provided in the provider, reviewer, and publisher interfaces (710, 810, and 910). In this regard, the search results field 1030 of the content-consumer interface 1010 presents the title, subject, date, and application used to, generate the associated digital asset 110.

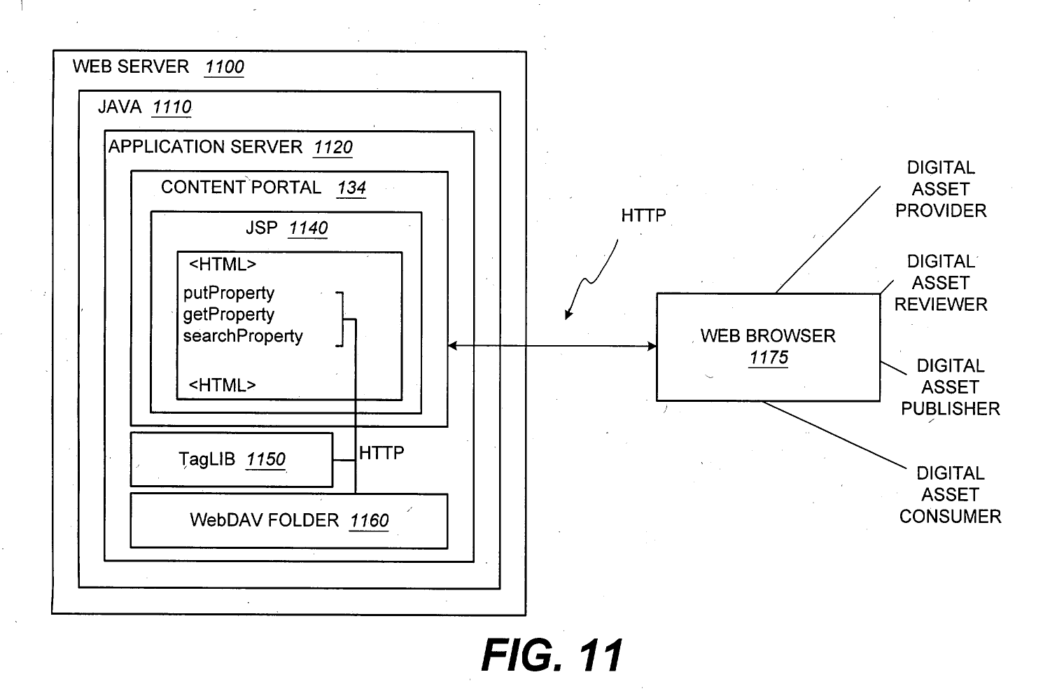

FIG. 11 illustrates a hierarchical view of various elements configured to enable digital asset operators acting in various roles to store, update, search, and otherwise exploit digital assets stored in a WeBDAV folder. As shown in FIG. 11, operators assuming the various roles of provider, reviewer, publisher, and consumer communicate via web browser 1175 and HTTP with content portal 134.

As further illustrated in FIG. 11, web server 1100 communicatively coupled to web browser 1175 via one or more wired or wireless communication networks is configured to support a Java software environment 1110. The Java software environment 1110 provides the software infrastructure for application server 1120. Application server 1120 is a J2EE compliant server. That is, application server 1120 provides libraries, interfaces, and data constructs that expose J2EE compliant servlets to client applications.

The application server 1120 receives web service requests in HTTP from web browser 1175 directed to content portal 134. The application server 1120 parses the web service request to extract arguments used to identify specific information associated with the client request. Content portal 134 receives the arguments from application server 1120 and uses Java server page (JSP) 1140 to identify tag library properties that will interface with the WebDAV folder 1160 to complete the web service request. The embodiment illustrated in FIG. 11 indicates that a putProperty tag, a getProperty tag and a searchProperty tag represented in HTML can be used to identify standard functions provided in tag library 1150 to communicate with WebDAV folder 1160.

The “putProperty,” “getProperty,” and “searchProperty” mechanisms are provided to remove the difficulties associated with storing, locating, and searching information in a WebDAV compliant data storage facility for programmers familiar only with HTML. For example, results are returned via getProperty variables to JSP 1140. Further programming instructions in JSP 1140 are configured to generate information in HTML format to JSP 1140. Content portal 134 can easily extract the result from the HTML information and construct a HTTP web service response which is forwarded to web browser 1175. Similar HTML encoded messages can be generated by suitably configured instructions in JSP 1140 associated with the putProperty and the searchProperty as desired.

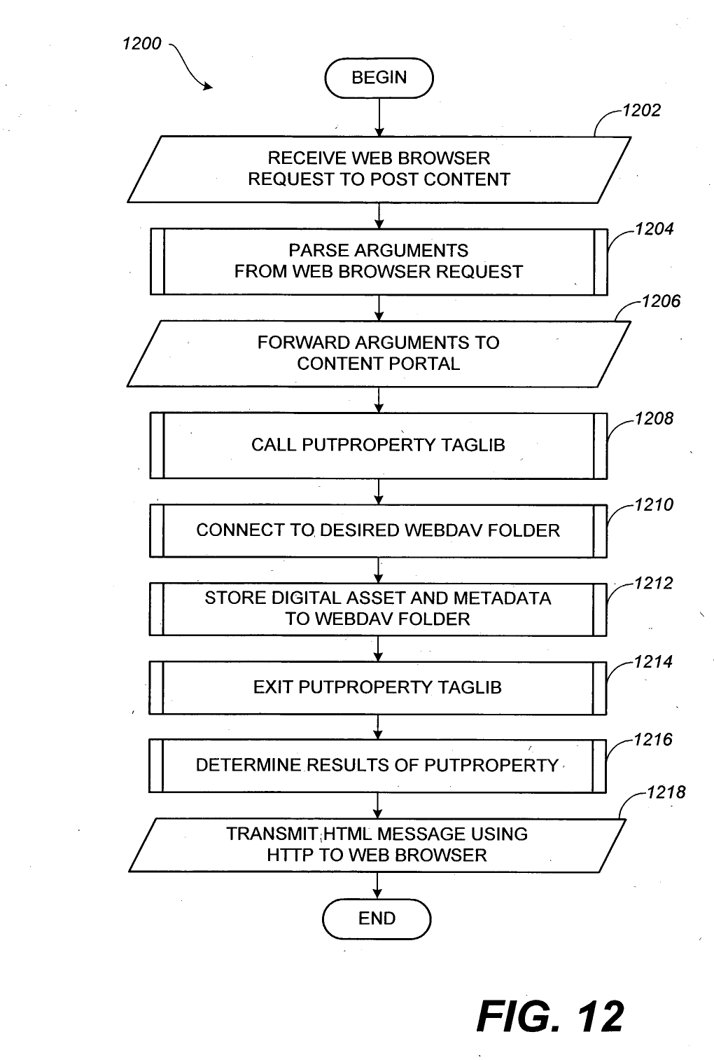

FIG. 12 is a flow diagram that illustrates a method 1200 for updating information in a WebDAV compliant storage facility such as WebDAV folder 1160. Method 1200 begins with input/output block 1202 where web server 1100 receives a web service request from web browser 1175 to post content in WebDAV folder 1160. Application server 1120 parses information provided in the web service request including command arguments or other parameters, such as variables, as indicated in block 1204. Next, in input/output block 1206, the command arguments are forwarded to content portal 134. Content portal 134 calls the putProperty tag library as shown in block 1208. The putProperty tag identifies a previously programmed interface constructed to perform all the necessary steps and reporting when storing information in a WebDAV compliant data store.

As further indicated in block 1210, the putProperty function connects to the designated WebDAV folder. In block 1212, the putProperty function stores the desired digital asset and/or metadata information in the WebDAV folder 1160. Those familiar with WebDAV will understand that a digital asset must be stored to WebDAV folder 1160 before metadata can be identified and stored to the WebDAV folder 1160. Digital asset and metadata storage are combined in block 1212 for simplicity of illustration. In block 1214, the putProperty exits after sending result information to the content portal 134 via JSP 1140. Thereafter, in block 1216, the content portal 134 confirms the results of the putProperty tag library function and forwards a HTML message, as indicated in input/output block 1218. The response transmission generated in input/output block 1218 is encoded in HTML and uses HTTP to communicate with web browser 1175 in accordance with the information returned from the WebDAV folder 1160.

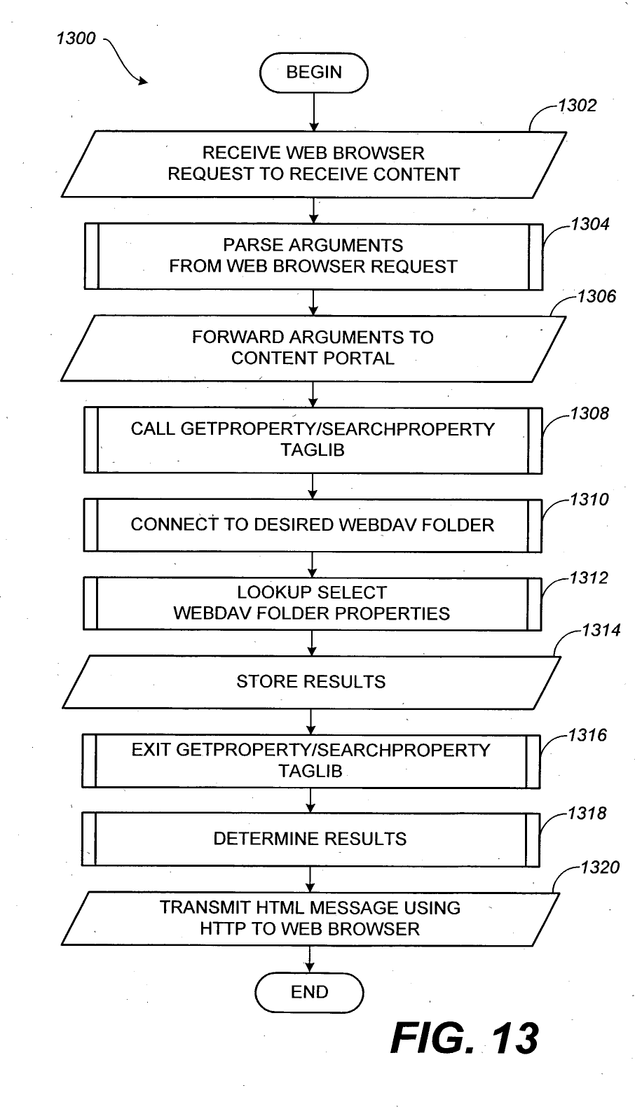

FIG. 13 is a flow diagram that illustrates a method 1300 for searching and retrieving information from a WebDAV compliant storage facility such as WebDAV folder 1160. Method 1300 begins with input/output block 1302 where web server 1100 receives a web service request from web browser 1175 to receive content from WebDAV folder 1160. Application server 1120 parses information provided in the web service request including command arguments or other parameters, such as variables, as indicated in block 1304. Next, in input/output block 1306, the command arguments are forwarded to content portal 134. Content portal 134 calls the searchProperty tag library and/or the getProperty tag library as shown in block 1308. The searchProperty tag identifies a previously programmed interface constructed to perform all the necessary steps and reporting when searching for information associated with multiple digital assets from a WebDAV compliant data store. The getProperty tag identifies a previously programmed interface constructed to perform all the necessary steps and reporting when retrieving information associated with a previously stored digital asset from a WebDAV compliant data store.

As further indicated in block 1310, the searchProperty function connects to the designated WebDAV folder. In block 1312, the searchProperty function or the get Property function looks up select WebDAV folder properties to locate the desired digital asset and/or metadata information in the WebDAV folder 1160. As indicated in input/output block 1314, the searchProperty stores the results in memory. Next, in block 1316, the searchProperty or getProperty exits after sending result information to the content portal 134 via JSP 1140. Thereafter, in block 1318, the content portal 134 confirms the results of the respective tag library function and forwards a HTML message, as indicated in input/output block 1320. The response transmission generated in input/output block 1320 is encoded in HTML and uses HTTP to communicate with web browser 1175 in accordance with the information returned from the WebDAV folder 1160.

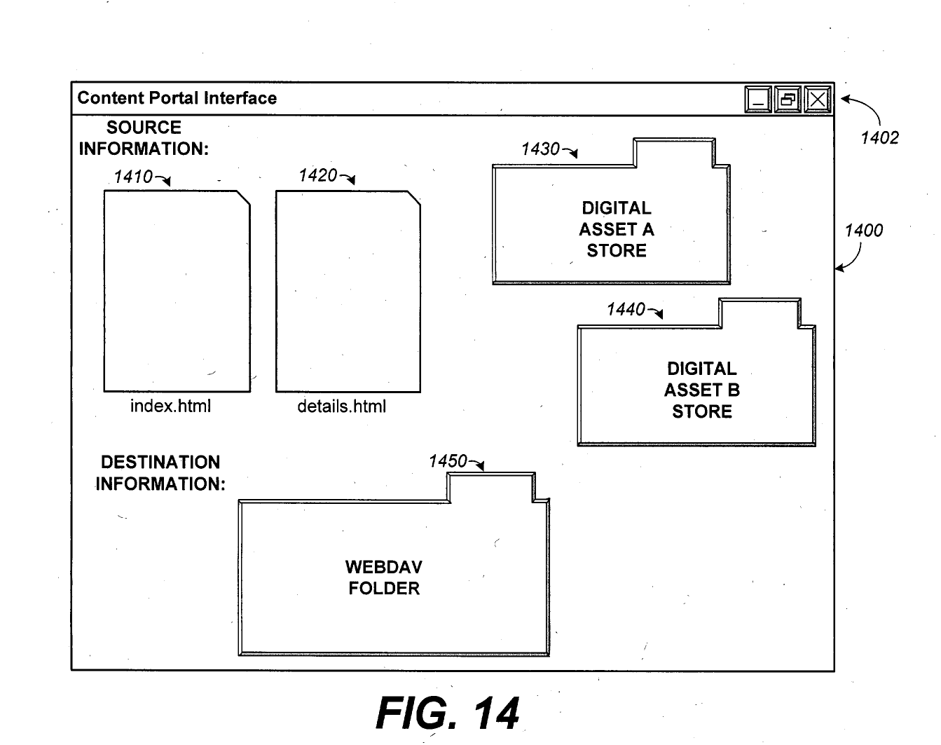

FIG. 14 contains a schematic diagram illustrating an embodiment of a web browser interface that organizes the various elements for a provider of the digital asset 110 that desires to integrate the digital asset in the WebDAV folder 1160. As illustrated in FIG. 14, content portal interface 1400 includes a title header 1402 that includes window minimize, maximize, and close window functional pushbuttons. As further illustrated in FIG. 14, content portal interface 1400 includes a body window that logically divides the area into source information and destination information portions. In the embodiment illustrated in FIG. 14, the source information portion is presented above the destination information. The source information portion includes index file 1410, details file 1420, digital asset A store 1430, and digital asset B store 1440. Destination information portion 1450 is a representation of a desired WebDAV store. A provider of digital assets A, B 1430, 1440, respectively, can use a pointing device coupled to the computing device used to operate web browser 1175 to graphically select and drag various components of source information that the provider desires to integrate in the WebDAV store. Once integrated, the one or more digital assets and associated metadata can be manipulated, searched, accessed, or otherwise exploited by a number of operators using content portal 134 as described above.

It should be emphasized that the above-described embodiments of the content portal 134 and the method for directing the integration of human-readable digital assets in a WebDAV data store, are merely possible examples of implementations, set forth to enable a clear understanding of the principles included in the content portal 134 and the method. Variations and modifications may be made to the above-described embodiment(s) of the invention without departing substantially from the principles described herein. All such modifications and variations are included within the scope of this disclosure and protected by the following claims.

The sequence listing below is an embodiment of a HTML encoded commands for communicating with a WebDAV data store via a suitably configured set of functions in a tag library. As described above, arguments and/or variables returned from the tag library functions can be forwarded to a suitably configured JSP, which in turn generates and forwards information in HTML to a content portal.

SEQUENCE LISTING

This document describes “get” TagLibs for obtaining and displaying
value strings. The requested values come from WebDAV and a
userproperty.xml file.
There are four tables below that give examples for getting
“subject”, “description”, and “published”. Depending on the
value of getType, passed in the TagLib call, the values
returned will vary, and will come from either the XML file
or WebDAV.
This TagLib enhances application development by hiding the details
under the covers. Additionally, the XML file and TagLib design
will enhance tailoring of the application.

| Get subject | What is Returned | Comes From |
|---|---|---|
| Display | Subject: | XML |
| Value | Unix Basics | WebDAV |
| HTML noval | <text name=“subject” | XML |
| | value=“” size=30> | |
| HTML withval | <text name=“subject” | XML & |
| | value=“Unix Basics” size=30> | WebDAV |

Example TagLib call:
<wdprop:getProperty shareName=“webdav/local” objectPath=“/test/joe.txt”>

<wdprop:get name=“subject” getType=“dn” outputVar=“dname” />
<wdprop:get name=“subject” getType=“vu” outputVar=“value” />
<wdprop:get name=“subject” getType=“hn” outputVar=“htmln” />
<wdprop:get name=“subject” getType=“hw” outputVar=“htmlw” />

</wdprop:getProperty>

| Get description | What is Returned | Comes From |
|---|---|---|
| Display | Description: | XML |
| Value | Larry discusses basic Unix commands | WebDAV |
| HTML noval | <textarea name=“description” | XML |
| | rows=“3” cols=“40”> | |
| | </textarea> | |
| HTML withval | <textarea name=“description” | XML & |
| | rows=“3” cols=“40”> | WebDAV |
| | Larry discusses basic Unix commands | |
| | </textarea> | |

Example TagLib call:
<wdprop:getProperty shareName=“webdav/local” objectPath=“/test/joe.txt”>

<wdprop:get name=“description” getType=“dn” outputVar=“dname” />
<wdprop:get name=“description” getType=“vu” outputVar=“value” />
<wdprop:get name=“description” getType=“hn” outputVar=“htmln” />
<wdprop:get name=“description” getType=“hw” outputVar=“htmlw” />

</wdprop:getProperty>

| Get published | What You Get Back in a Variable | Comes From |
|---|---|---|
| Display | Published: | XML |
| Value | Yes | WebDAV |
| HTML noval | <select name=“published”> | XML |
| | <option value=“No”>No</option> | |
| | <option value=“Yes”>Yes</option> | |
| | </select> | |
| HTML withval | <select name=“published”> | XML & |
| | <option value=“No”>No</option> | WebDAV |
| | <option value=“Yes” | |
| | selected>Yes</option> | |
| | </select> | |

Example TagLib call:
<wdprop:getProperty shareName=“webdav/local” objectPath=“/test/joe.txt”>

<wdprop:get name=“published” getType=“dn” outputVar=“dname” />
<wdprop:get name=“published” getType=“vu” outputVar=“value” />
<wdprop:get name=“published” getType=“hn” outputVar=“htmln” />
<wdprop:get name=“published” getType=“hw” outputVar=“htmlw” />

</wdprop:getProperty>
getType
dn = Display Name
vu = Value
hn = HTML without value set
hw = HTML with value set
Example put tag:
<wdprop:putProperty shareName=“webdav/local” objectPath=“/test/joe.txt”>

<wdprop:set name=“W1” value=“ww” />
<wdprop:set name=“X2” value=“xx” />
<wdprop:set name=“Y3” value=“yy 3” />
<wdprop:set name=“Z4” value=“Z4=hi” />

</wdprop:putProperty>
---------------------------------------------------------------------------------
Sample userproperties.xml file:
---------------------------------------------------------------------------------
<?xml version=“1.0” encoding=“UTF-8”?>
<userproperties>

<userproperty name=“subject” display=“Subject”
viewType=“0” htmlType=“text”

attributes=‘size=“20”’ />

<userproperty name=“description” display=“Description”
viewType=“0” htmlType=“textarea”

attributes=‘rows=“3” cols=“40”’ />

<userproperty name=“requires” display=“Requires”
viewType=“0” htmlType=“select”>

<option value=“Adobe Acrobat Reader” display=“Adobe Acrobat Reader” />
<option value=“Real Player” display=“Real Player” />
<option value=“Macromedia Flash” display=“Macromedia Flash” />
<option value=“Macromedia Shockwave”
display=“Macromedia Shockwave” />
<option value=“Microsoft PowerPoint” display=“Microsoft PowerPoint” />
<option value=“Windows Media Player” display=“Windows Media Player” />

</userproperty>
<userproperty name=“published” display=“Published”
viewType=“0” htmlType=“select”>

<option value=“No” display=“No” />
<option value=“Yes” display=“Yes” />

</userproperty>

</userproperties>
viewType
00 = Don't show in Master View, NOT searchable
01 = Don't show in Master View, IS searchable
10 = Show in Master View, NOT searchable
11 = Show in Master View, IS searchable
---------------------------------------------------------------------------------
Example usage in a JSP:
---------------------------------------------------------------------------------
<%@page contentType=“text/html”
%>
<%

String subjectDN = null, subjectHTML = null;
String descriptionDN = null, descriptionHTML = null;
String requiresDN = null, requiresHTML = null;
String publishedDN = null, publishedHTML = null;

%>
<%@ taglib uri=“/webdav” prefix=“wdprop” %>
<wdprop:getProperty shareName=“webdav/local” objectPath=“/test”>

<wdprop:get name=“subject” getType=“dn” outputVar=“subjectDN” />
<wdprop:get name=“subject” getType=“hw” outputVar=“subjectHTML” />
<wdprop:get name=“description” getType=“dn” outputVar=“descriptionDN” />
<wdprop:get name=“description” getType=“hw” outputVar=“descriptionHTML” />
<wdprop:get name=“requires” getType=“dn” outputVar=“requiresDN” />
<wdprop:get name=“requires” getType=“hw” outputVar=“requiresHTML” />
<wdprop:get name=“published” getType=“dn” outputVar=“publishedDN” />
<wdprop:get name=“published” getType=“hw” outputVar=“publishedHTML” />

</wdprop:getProperty>
<html>
<head>
<title>Joe Taglib Get Test</title>
</head>
<body>
<h1>Joe Taglib Get Test</h1>
<p>
<%= subjectDN %>: <%= subjectHTML %>
<p>
<%= descriptionDN %>: <%= descriptionHTML %>
<p>
<%= requiresDN %>: <%= requiresHTML %>
<p>
<%= publishedDN %>: <%= publishedHTML %>
</body>
</html>
---------------------------------------------------------------------------------
HTML Output From Above JSP:
---------------------------------------------------------------------------------
<html>
<head>
<title>Joe Taglib Get Test</title>
</head>
<body>
<h1>Joe Taglib Get Test</h1>
<p>
Subject: <input type=“text” name=“subject” value=“RadPak Intro” size=“20”>
<p>
Description: <textarea name=“description” rows=“3” cols=“40”>
Learn about RadPak from Bill</textarea>
<p>
Requires: <select name=“requires”>
<option value=“Adobe Acrobat Reader”>Adobe Acrobat Reader</option>
<option value=“Real Player”>Real Player</option>
<option value=“Macromedia Flash”>Macromedia Flash</option>
<option value=“Macromedia Shockwave”>Macromedia Shockwave</option>
<option value=“Microsoft PowerPoint”>Microsoft PowerPoint</option>
<option value=“Windows Media Player” selected>Windows Media Player</option>
</select>
<p>
Published: <select name=“published”>
<option value=“No” selected>No</option>
<option value=“Yes”>Yes</option>
</select>
</body>
</html>

We claim:

1. A content management portal, comprising:
a user interface configured to receive information from a client via a web browser, the information associated with a human-readable digital asset, wherein the web browser presents a graphical user interface configured to render a representation of the human-readable digital asset; and
a management engine coupled to the user interface, wherein the management engine is configured to use a hypertext markup language tag library to communicate with a WebDAV compatible storage device.

2. The content management portal of claim 1, wherein the user interface is configured to support a plurality of operator roles.

3. The content management portal of claim 2, wherein the user interface supports operator roles of at least a provider, a publisher, and a consumer.

4. The content management portal of claim 3, wherein when the user interface supports the user role of a provider, the web browser presents a representation of the WebDAV compatible storage device.

5. The content management portal of claim 4, wherein the WebDAV compatible storage device is represented as a folder.

6. The content management portal of claim 1, wherein the human-readable digital asset comprises: video information, audio information, audio-visual information, dynamic documents, and slide presentations.

7. The content management portal of claim 1, wherein the management engine is further configured to report results in hypertext markup language.

8. The content management portal of claim 1, wherein the user interface is further configured to enable a consumer using a web browser to locate the human-readable digital asset.

9. A computer-readable medium having stored thereon an executable instruction set, the instruction set, when executed by a processor, directs the processor to perform a method, comprising:
receiving a human-readable digital asset and an associated metadata index communicated from a graphical user interface via a web browser; and
using a tag library to communicate information about the human-readable digital asset and the associated metadata index to a WebDAV compatible storage device.

10. The computer-readable medium of claim 9, wherein receiving a human-readable digital asset and the associated metadata index comprises receiving information in hypertext markup language.

11. The computer-readable medium of claim 9, wherein receiving a human-readable digital asset comprises receiving a human-readable digital asset selected from the group consisting of video information, audio information, audio-visual information, dynamic documents, and slide presentations.

12. The computer-readable medium of claim 9, wherein using a tag library to communicate information about the human-readable digital asset comprises using tag library commands to store data in the WebDAV compatible storage device.

13. The computer-readable medium of claim 9, wherein using a tag library to communicate information about the human-readable digital asset comprises using tag library commands to retrieve data from the WebDAV compatible storage device.

14. A method for communicating media content, comprising:
receiving information associated with a human-readable digital asset and related metadata communicated from a graphical user interface via a web browser;
parsing the information to extract an argument;
using a tag library to connect with a WebDAV compatible storage device in response to the argument;
using the tag library to forward the parsed information to the WebDAV compatible storage device; and
using the tag library to return a result to a content portal.

15. The method of claim 14, further comprising:
using the parsed information to determine a result.

16. The method of claim 14, wherein using the tag library further comprises using hypertext markup language.

17. A method for communicating media content, comprising:
receiving information associated with a human-readable digital asset and related metadata communicated from a graphical user interface via a web browser;
parsing the information to extract an argument;
using a tag library to connect with a WebDAV compatible storage device in response to the argument;
using the tag library to search parsed information in the WebDAV compatible storage device to generate a result;
using the tag library to store the result; and
using the tag library to return the result to a content portal.

18. The method of claim 17, receiving information associated with a human-readable digital asset comprises receiving a human-readble asset selected from the group consisting of copying video information, audio information, audio-visual information, dynamic documents, and slide presentations.

19. The method of claim 17, further comprising:
using the content portal to return the result to the client.

20. The method of claim 19, wherein using the content portal to return the result to the client comprises a hypertext markup language encoded message transmitted using hypertext transfer protocol.

21. A content management portal, comprising:
means for receiving information associated with a human-readable digital asset;
means for presenting a representation of the human-readable digital asset; and
means for communicating with a WebDAV compatible storage device that contains the human-readable digital asset.

22. The content management portal of claim 21, wherein the means for presenting a representation of the human-readable digital asset is configured to support a plurality of operator roles.

23. The content management portal of claim 22, wherein the means for presenting a representation of the human-readable digital asset supports operator roles of at least a provider, a publisher, and a consumer.

24. The content management portal of claim 23, wherein when the means for presenting a representation of the human-readable digital asset supports the user role of a provider, a presentation comprises a representation of the WebDAV compatible storage device.

25. The content management portal of claim 24, wherein the WebDAV compatible storage device is presented as a folder.

26. The content management portal of claim 21, wherein the means for receiving information associated with a human-readable digital asset comprises a digital asset selected from the group consisting of video information, audio information, audio-visual information, dynamic documents, and slide presentations.

27. The content management portal of claim 21, wherein the means for communicating with a WebDAV compatible storage device is further configured to report results in hypertext markup language.

28. The content management portal of claim 21, wherein the means for presenting a representation of the human-readable digital asset is further configured to enable a consumer using a web browser to locate the human-readable digital asset.
